(19) United States
(12) Patent Application Publication
(10) Pub. No.: US 2018/0003562 A1
(43) Pub. Date: Jan. 4, 2018

(54) INFORMATION PROCESSOR, NON-TRANSITORY COMPUTER READABLE MEDIUM, AND INFORMATION PROCESSING METHOD

(71) Applicant: FUJI XEROX CO., LTD., Tokyo (JP)

(72) Inventor: Takuhiro TOGASHI, Kanagawa (JP)

(73) Assignee: FUJI XEROX CO., LTD., Tokyo (JP)

(21) Appl. No.: 15/352,451

(22) Filed: Nov. 15, 2016

(30) Foreign Application Priority Data
Jun. 30, 2016 (JP) 2016-131000

(51) Int. Cl. G01J 3/52; G01J 3/50

(52) U.S. Cl. CPC G01J 3/524; G01J 3/50

(57) ABSTRACT

An information processor includes an acquisition unit that acquires a colorimetric value from a colorimeter that scans a color chart and measures color; and an output unit that assigns a weighting value according to a position in a scanning interval of the color chart, and that outputs a weighted average value of the colorimetric value of multiple patches for a color setting value.

### CROSS-REFERENCE TO RELATED APPLICATIONS

This application is based on and claims priority under 35 USC 119 from Japanese Patent Application No. 2016-131000 filed on Jun. 30, 2016.

### BACKGROUND

### Technical Field

The present invention relates to an information processor, a non-transitory computer readable medium, and an information processing method.

### SUMMARY

According to an aspect of the invention, there is provided an information processor including: an acquisition unit that acquires a colorimetric value from a colorimeter that scans a color chart and measures color; and an output unit that assigns a weighting value according to a position in a scanning interval of the color chart, and that outputs a weighted average value of the colorimetric value of multiple patches for a color setting value.

### BRIEF DESCRIPTION OF THE DRAWINGS

Exemplary embodiments of the present invention will be described in detail based on the following figures, wherein:

FIG. 1 is a diagram showing the entire configuration of an exemplary embodiment;

FIG. 2 is a diagram showing a hardware configuration of an information processor;

FIG. 3 is a diagram showing a hardware configuration of a colorimeter;

FIG. 4 is a diagram showing a hardware configuration of a printer;

FIG. 5 is an illustration showing a color chart;

FIG. 6 is an illustration showing a ruler;

FIG. 7 is an illustration showing the content of a pattern file;

FIG. 8 is a flowchart showing the steps of processing a colorimetric value;

FIG. 9 is a table showing the content of a colorimetric value file;

FIG. 10 is a table showing the content of a result file;

FIG. 11 is a graph showing an example of weighting value Wp;

FIG. 12 is a graph showing an example of weighting value Wt; and

FIG. 13 is a table showing the content of a colorimetric value database.

### DETAILED DESCRIPTION

An example of an embodiment for practicing the invention will be described.

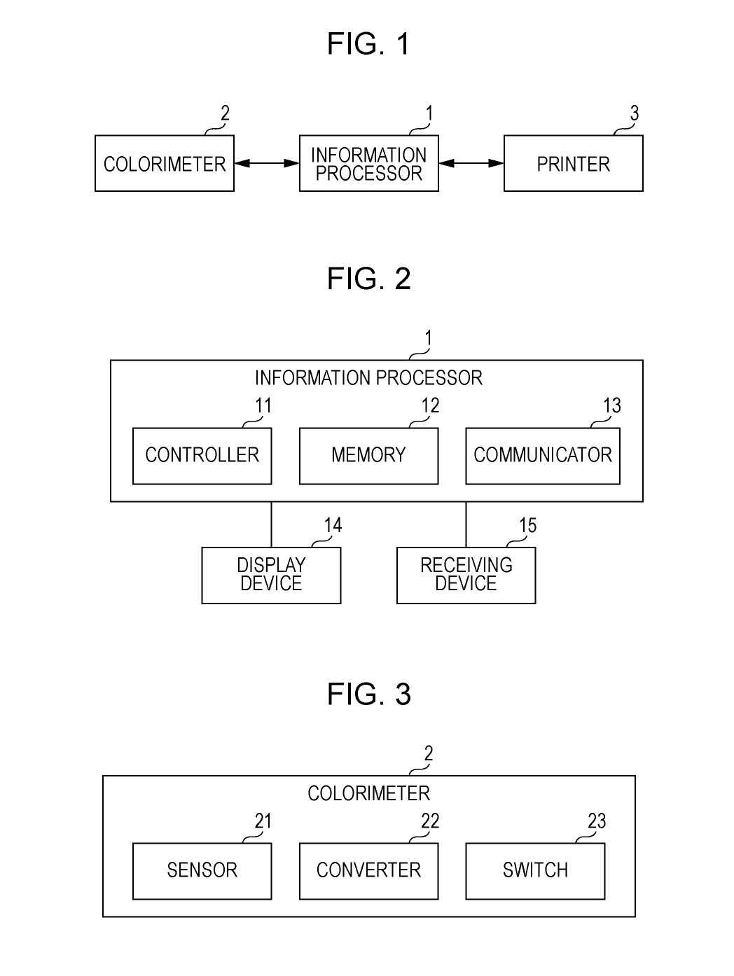

FIG. 1 is a diagram showing the entire configuration of an exemplary embodiment. A colorimeter 2 measures a color chart printed by a printer 3 and outputs a colorimetric value to an information processor. The information processor 1 performs processing on the colorimetric value in accordance with predetermined steps to create a profile, and outputs the profile to the printer 3. The printer 3 performs color conversion on inputted print data in accordance with the profile and executes printing.

FIG. 2 is a diagram showing the hardware configuration of the information processor 1. The information processor 1 is, for instance, a personal computer. A controller 11 includes an arithmetic unit such as a central processing unit (CPU), and a storage unit such as a read only memory (ROM) and a random access memory (RAM). The ROM stores firmware that describes a procedure for starting-up hardware and an operating system (OS). The RAM stores the data used when the CPU performs arithmetic operations. A memory 12 includes a hard disk storage unit and/or a semiconductor memory, and stores the OS and application programs. A communicator 13 is a communication interface (I/F) for connecting the information processor 1 to a communication unit such as a local area network (LAN). The information processor 1 is connected to a display device 14 and a receiving device 15. The display device 14 includes, for instance, a liquid crystal display, and displays a screen for an operator to operate the information processor 1. The receiving device 15 includes, for instance, a keyboard and a pointing device, and receives an operation performed by an operator and outputs information according to the operation to the controller 11. It is to be noted that the display device 14 and the receiving device 15 may be integrated with the information processor 1.

FIG. 3 is a diagram showing the hardware configuration of the colorimeter 2. The lower surface of the housing of the colorimeter 2 is provided with a sensor 21. The sensor 21 includes a light source and a spectroscope. The light source irradiates the color chart with light, and the spectroscope disperses reflection light from the color chart to output a spectrum. A converter 22 converts the spectrum into colorimetric values such as L*, a*, b* in a CIELAB color space as an instance, and outputs the colorimetric values to the information processor 1. The colorimeter 2 includes a switch 23 for switching ON/OFF of the operation of the sensor 21, and measures color and outputs a colorimetric value at a predetermined frequency (for instance, on the order of several hundreds of times per second) while the switch is kept ON by an operator.

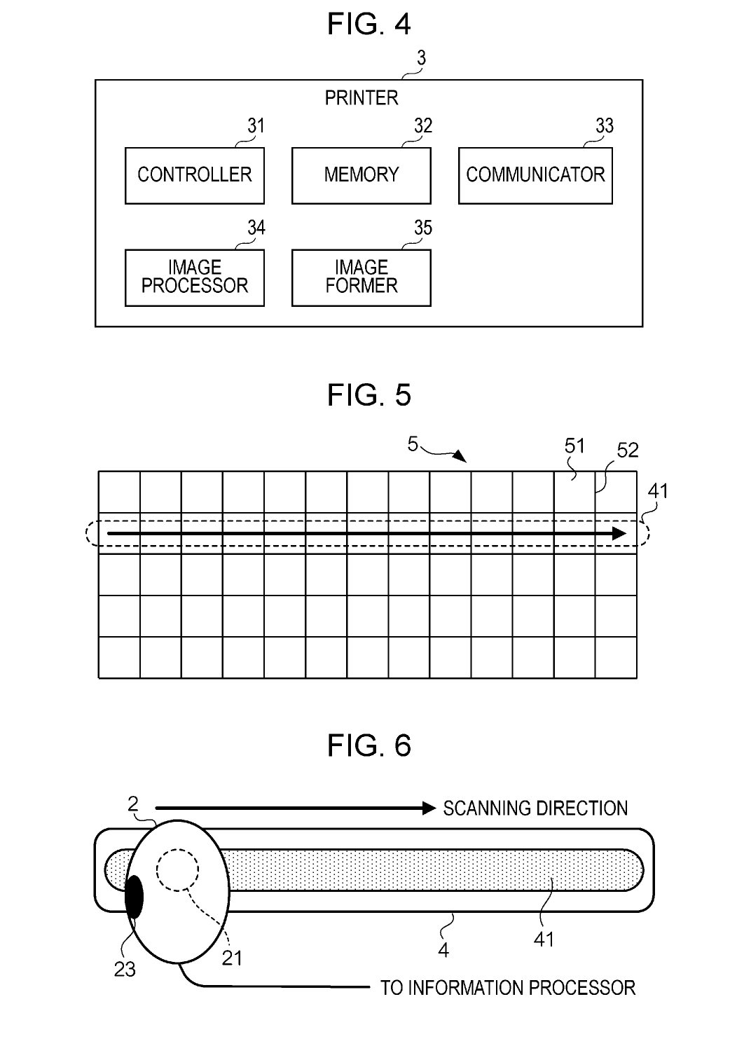

FIG. 4 is a diagram showing the hardware configuration of the printer 3. A controller 31 includes an arithmetic unit such as a CPU, and a storage unit such as a ROM and a RAM. The ROM stores firmware that describes a procedure for starting-up hardware and an OS. The RAM stores the data used when the CPU performs arithmetic operations. A memory 32 includes a hard disk storage unit and/or a semiconductor memory, and stores the OS and application programs. A communicator 33 is a communication I/F for connecting the printer 3 to a communication unit such as a LAN. The storage 32 stores a profile outputted from the information processor 1, and an image processor 34 generates raster data by performing color conversion on page description language (PDL) data in accordance with the profile. An image former 35 forms an image based on the raster data on a sheet-shaped recording medium by a system such as an electrophotographic or ink-jet system.

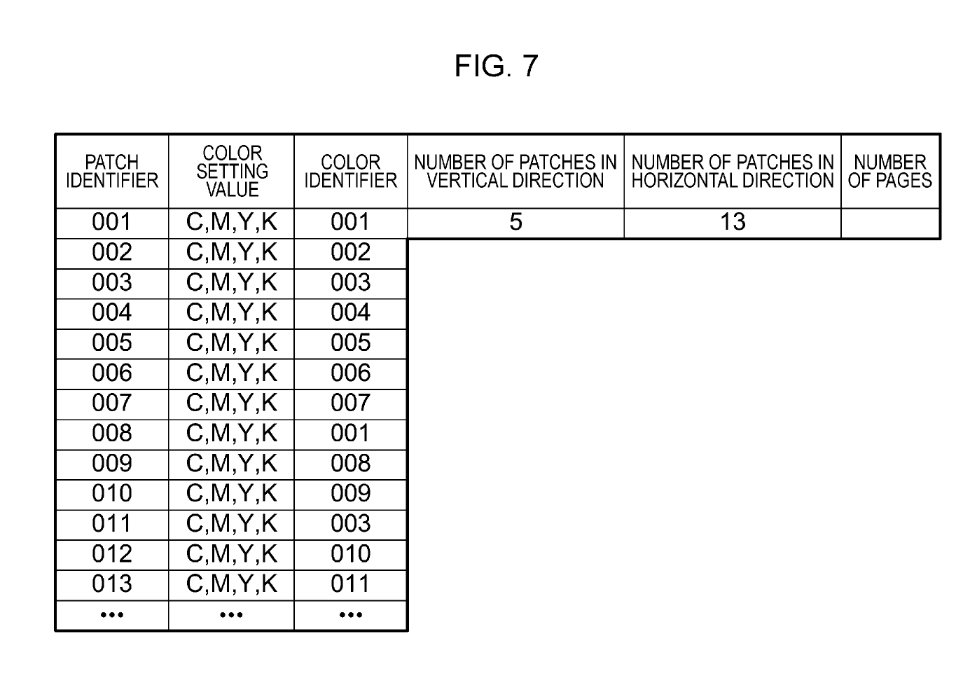

FIG. 5 is an illustration showing a color chart 5. FIG. 7 is an illustration showing the content of a pattern file. The color chart 5 is formed by arranging multiple rectangular patches 51 in a matrix form. The memory 12 of the information processor 1 stores a pattern file that shows the configuration of the color chart 5. When directions for printing the color chart 5 are given to the information processor 1, the controller 11 outputs the image data of the color chart 5 based on the pattern file to the printer 3.

The pattern file includes a patch identifier, a color setting value, a color identifier, the number of patches in a vertical direction, the number of patches in a horizontal direction, the number of pages of the color chart. The patch identifier is one of serial numbers corresponding to the sequence of color measurement of patches, for instance. In the exemplary embodiment, the uppermost row of the color chart 5 is first scanned from the left to the right, and scanning in this direction is made row by row downward from the uppermost row. The scanning direction and the sequence of rows are specified in advance by an application program in order to identify a correspondence between a colorimetric value and a patch, and an operator scans the color chart in accordance with the specified scanning direction and sequence of rows. It is to be noted that the above scanning direction and sequence of rows are only an example, and different scanning direction and sequence of rows may be specified. Alternatively, a configuration may be adopted in which a scanning direction and a sequence of rows are set in the information processor 1 by an operator.

The color setting value is data indicating a color that is set to each patch, and is expressed, for instance, by a set of values of cyan (C), magenta (M), yellow (Y), and black (K) in a CMY color space. The color identifier is an identifier for identifying a color that is set to each patch, and the same color identifier is assigned to patches having a common color setting value. It is to be noted that although the color identifier may be included in the pattern file in advance, the controller 11 may be configured to extract a set of patches having the same color setting value from a pattern file with no color identifier included, and to assign a color identifier to each set to add the color identifier to the pattern file.

The color chart 5 is configured to include multiple patches 51 for each color setting value, and the multiple patches 51 with the same color setting value assigned are arranged in a dispersed manner so as not to be adjacent to each other. Between adjacent patch 51 and patch 51, a gap (for instance, a width of approximately 1/10 of a patch) narrower than the patch 51 in width is provided. The gap is called a separator 52. A color setting value is set to each separator 52 in such a manner that a color difference (may be a brightness difference) between the separator 52 and the two patches 51 adjacent to the separator 52 is a first threshold value or greater. For instance, when black satisfies this condition, black is set to the separator, when black does not satisfy this condition, white is set to the separator, and when neither black nor white satisfies this condition, another color is set to the separator.

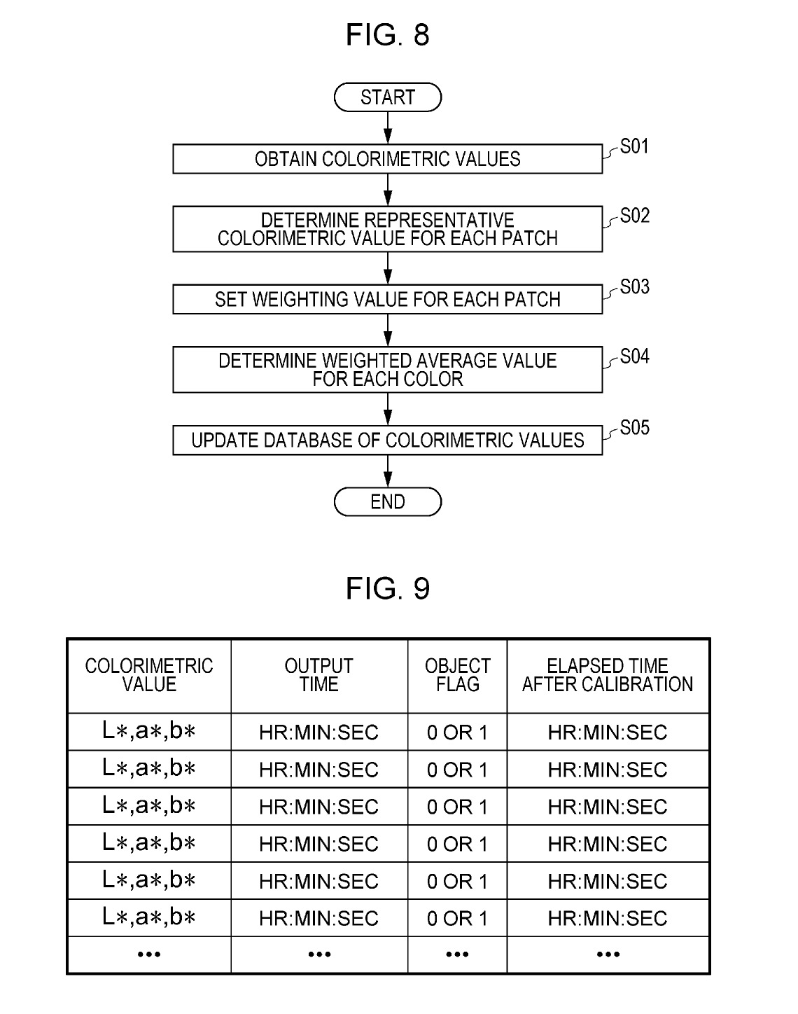

FIG. 8 is a flowchart showing the steps of processing a colorimetric value. In the information processor 1, an application program, which describes the steps for processing a colorimetric value, is installed, and the controller 11 performs the following processing in accordance with the steps.

<Step S01>

The information processor 1 acquires a colorimetric value from the colorimeter 2. Specifically, this step is as follows.

FIG. 6 is an illustration showing a ruler 4. The ruler 4 is provided with a window 41 having a size corresponding to the patches in one row of the color chart 5. The sensor 21 of the colorimeter 2 projects from the lower surface of the housing, and the height of the projection corresponds to the thickness of the ruler 4. An operator places the ruler 4 on the color chart so that the patches in one row appear through the window 41, inserts the sensor 21 in the window 41 of the ruler 4, moves the colorimeter 2 from the left end to the right end of the window 41 with the switch turned ON, and turns OFF the switch when the sensor 21 reaches the right end of the window 41. This work is performed row by row downward from the uppermost row of the color chart.

When the color difference between the latest colorimetric value outputted from the colorimeter 2 and the colorimetric value outputted immediately before the latest one is the first threshold value or greater, the controller 11 determines that an object of color measurement has changed from a patch 51 to a separator 52 or from a separator 52 to a patch 51, then reverses a flag. The flag is called an object flag. Each time a colorimetric value is outputted, the controller 11 stores the colorimetric value, the output time, and the object flag in the RAM in association with each other.

In addition, the controller 11 stores elapsed time after calibration of the colorimeter 2 in the RAM in association with a colorimetric value. Specifically, each time calibration of the colorimeter 2 is completed, the colorimeter 2 notifies the information processor 1 of the completion of calibration, and the controller 11 of the information processor 1 stores a completion time of calibration (hereinafter referred to as a calibration completion time) in the RAM. Each time a colorimetric value is outputted, the controller 11 determines elapsed time (the difference between the calibration completion time and the output time) after the calibration, and stores the elapsed time in the RAM in association with the colorimetric value.

FIG. 9 is a table showing the content of a colorimetric value file. When an operator directs the information processor 1 to output a colorimetric value to a file, the controller 11 outputs sets of a colorimetric value, an output time, and an object flag stored so far in the RAM to a file in the ascending order of the output time. The file is called a colorimetric value file.

<Step S02>

The controller 11 determines a representative colorimetric value for each patch. In the exemplary embodiment, the scanning speed varies with operators due to manual scanning, and the scanning speed also varies with the same operator. Therefore, the number of times of color measurement per patch, per separator also changes, and when it is assumed that the width of each patch 51 is 10 times the width of each separator 52, the number of times of color measurement per patch is approximately 10 times the number of times of color measurement per separator. Thus, for instance when “1” is continuously outputted as an object flag about 100 times, subsequently, “0” is continuously outputted about 10 times, and subsequently, “1” is continuously outputted about 100 times, “1” corresponds to the colorimetric value of each patch 51 and “0” corresponds to the colorimetric value of each separator 52, and in this manner, it is determined whether the object of color measurement is the patch 51 or the separator 52 by comparison between continuous lengths of the same value of the object flag. By this technique, the controller 11 extracts the colorimetric value for each patch sequentially from the head of the colorimetric value file, and determines the colorimetric value (hereinafter referred to as the representative colorimetric value) that represents each patch. The representative colorimetric value may be determined in any manner. For instance, the arithmetic average of multiple colorimetric values for each patch may serve as a representative colorimetric value, or one (for instance, the colorimetric value with the earliest output time, or the colorimetric value with the latest output time) of the colorimetric values for each patch may serve as a representative colorimetric value.

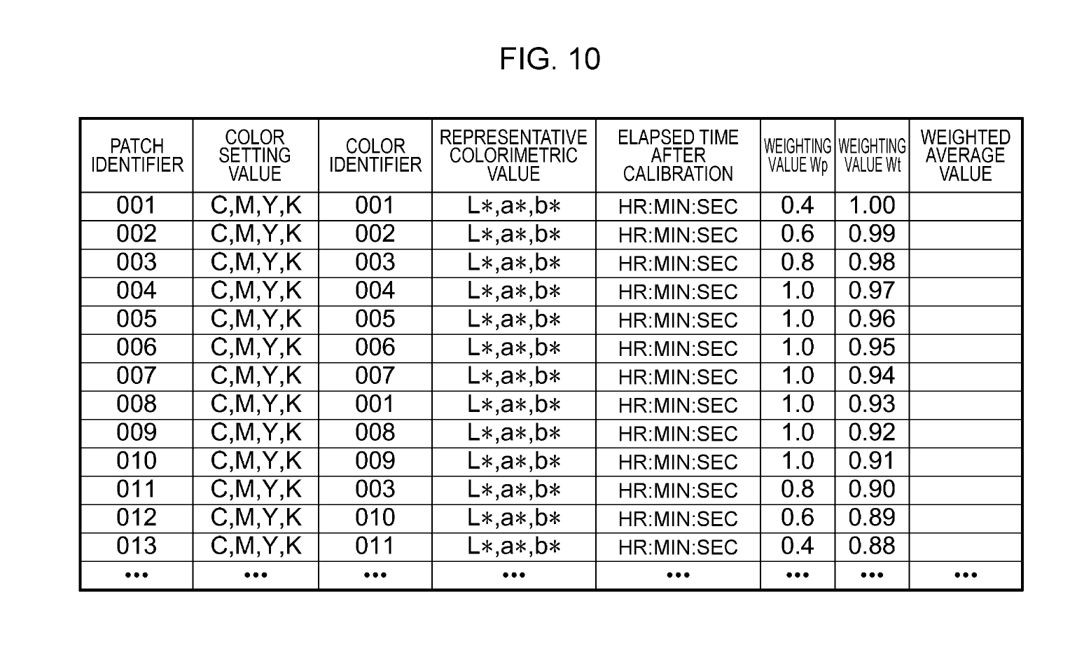

FIG. 10 is a table showing the content of a result file. The controller 11 outputs a patch identifier, a color setting value, a color identifier, a representative colorimetric value, and elapsed time after calibration to a file in association with each other. The file is called a result file. In the case where one of the colorimetric values for each patch serves as a representative colorimetric value, the elapsed time after calibration corresponds to the one colorimetric value. In the case where the arithmetic average of the colorimetric values for each patch serves as a representative colorimetric value, the elapsed time after calibration may be, for instance, the elapsed time after calibration corresponding to the colorimetric value with the earliest output time, or the colorimetric value with the latest output time out of the multiple colorimetric values. In FIG. 10, for the convenience of description, the data of the patches in one row (13 patches in this example) is illustrated. The patch identifier 001 indicates the patch at the left end (start point), and the patch identifier 013 indicates the patch at the right end (end point).

<Step S03>

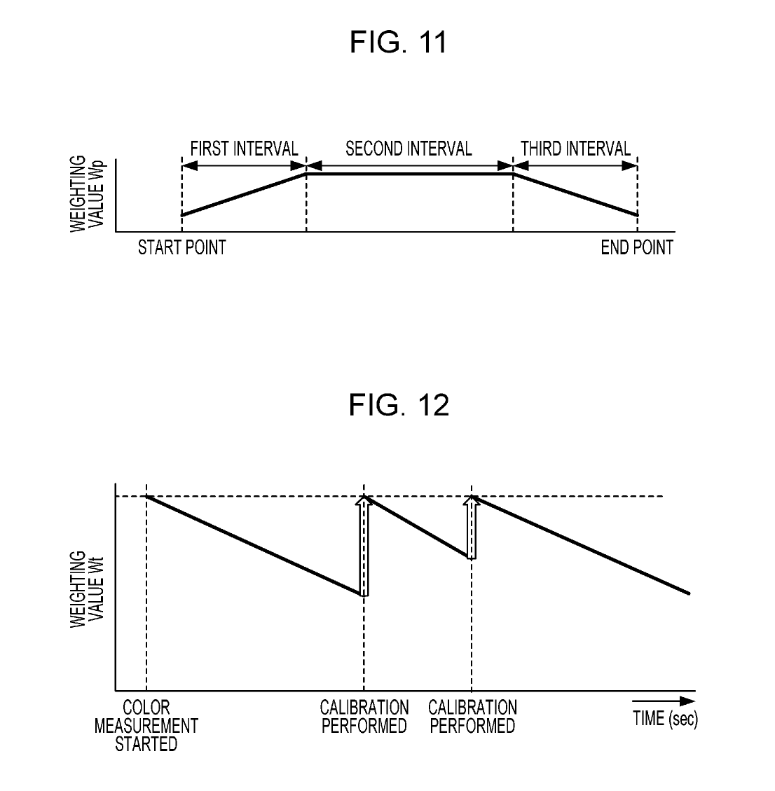

The controller 11 sets a weighting value for each patch. FIG. 11 is a graph showing an example of weighting value Wp. The weighting value Wp is a weighting value according to a position in a scanning interval of the color chart. The scanning interval is an interval from the start point (left end) to the end point (right end) for scanning of one row. In the exemplary embodiment, the scanning interval is divided into three intervals according to a movement speed of the colorimeter 2. The first interval is an interval which includes the start point and in which the movement speed of the colorimeter 2 increases from a resting state. In the second interval, the movement speed is stable. The third interval is an interval which includes the end point and in which the movement speed decreases and the colorimeter 2 reaches a resting state.

In the first interval and the third interval, the movement speed is unstable compared with the second interval, and thus the accuracy of color measurement is lower compared with the second interval. Thus, in the exemplary embodiment, in the first interval and the third interval (an example of an interval including an end point of the scanning interval and shorter than the scanning interval), the weighting value Wp is made smaller than in the second interval. Also, in the first interval, the degree of instability of the movement speed decreases as the position is closer to the left end of the second interval from the start point. In the third interval, the degree of instability of the movement speed increases as the position is closer to the end point from the right end of the second interval. Thus, in the exemplary embodiment, in the first interval and the third interval, the weighting value Wp is increased as the position is further away from an end point of the scanning interval. The weighting value Wp in the second interval is a constant value equal to the maximum value of the weighting value Wp in the first interval and the third interval.

A calculation expression or a lookup table showing the relationship between a position in the scanning interval and weighting value Wp is set in an application program, and for each patch identifier, the controller 11 determines a weighting value Wp corresponding to the position of the patch, then outputs the weighting value Wp to a result file in association with the patch identifier. The position in the scanning interval may be expressed, for instance, by the number of patches from the start point. In this case, the number of patches from the start point is given by the remainder of division of the patch identifier by the number of patches in the crosswise direction. Alternatively, the position in the scanning interval may be expressed by the distance from the start point. In this case, the position of each patch is identified by the number of patches from the start point and the widths (known) of each patch and each separator. In the result file of FIG. 10, the patch identifiers 001 to 004 correspond to the first interval, the patch identifiers 004 to 010 correspond to the second interval, and the patch identifiers 010 to 013 correspond to the third interval.

FIG. 12 is a graph showing an example of weighting value Wt. The weighting value Wt is a weighting value according to elapsed time after calibration of the colorimeter 2. The accuracy of a colorimetric value decreases with elapsed time after calibration of the colorimeter 2. Thus, in the exemplary embodiment, the weighting value Wt is decreased as elapsed time after calibration of the colorimeter 2 increases. For instance, a calculation expression or a lookup table showing the relationship between elapsed time after calibration and weighting value Wt is set in an application program, and for each patch identifier, the controller 11 determines a weighting value Wt corresponding to elapsed time after calibration based on the calculation expression, then outputs the weighting value Wt to a result file in association with the patch identifier. FIG. 12 illustrates an example in which scanning of the first row is started immediately after calibration is performed. In the example, the weighting value Wt is set so that the weighting value Wt is 1.00 at the start point (patch identifier 001) for scanning, and subsequently, the weighting value Wt decreases as time elapses. Also, each time calibration is performed, the weighting value Wt is returned to 1.00, and the weighting value Wt decreases as time elapses.

<Step S04>

The controller 11 determines the weighted average value of the colorimetric values of multiple patches for each color setting value. Expression (1) is a formula for the weighted average value of L*, where numerical subscripts (1, 2, . . . , N) added to L, Wp, Wt on the right-hand side are serial numbers assigned in ascending order of patch identifiers corresponding to N patches with the same color setting value and color identifier set. Similarly, Expression (2) is a formula for the weighted average value of a*, and Expression (3) is a formula for the weighted average value of b*.

L_{avg}=L₁Wₚ₁Wₜ₁+L₂Wₚ₂Wₜ₂+ . . . +L_{N}W_{pN}W_{tN}/Wₚ₁Wₜ₁+Wₚ₂Wₜ₂+ . . . +W_{pN}W_{tN} Expression (1)

a_{avg}=a₁Wₚ₁Wₜ₁+a₂Wₚ₂Wₜ₂+ . . . +a_{N}W_{pN}W_{tN}/Wₚ₁Wₜ₁+Wₚ₂Wₜ₂+ . . . +W_{pN}W_{tN} Expression (2)

b_{avg}=b₁Wₚ₁Wₜ₁+b₂Wₚ₂Wₜ₂+ . . . +b_{N}W_{pN}W_{tN}/Wₚ₁Wₜ₁+Wₚ₂Wₜ₂+ . . . +W_{pN}W_{tN} Expression (3)

The controller 11 outputs the calculated weighted average values to the result file in association with the corresponding patch identifier. Consequently, the weighted average value corresponding to the same color setting value is the same.

<Step S05>

The controller 11 updates a colorimetric value database.

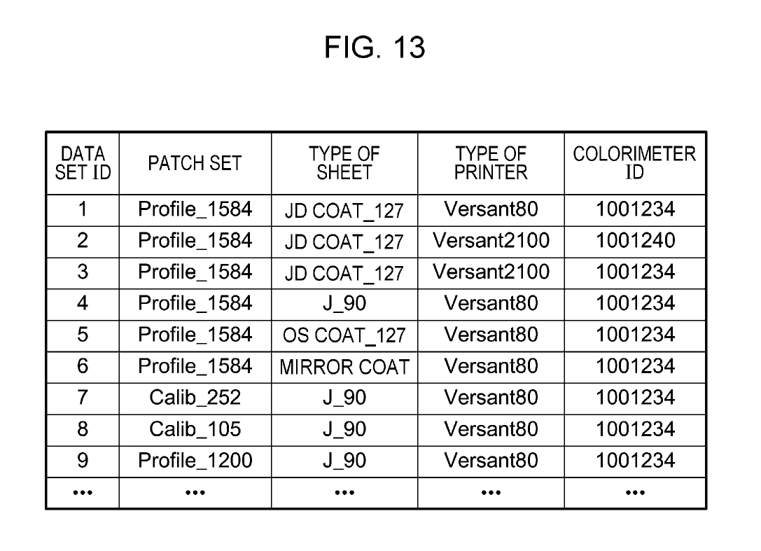

FIG. 13 is a table showing the content of the colorimetric value database. Based on the result file created in the above-described steps, the controller 11 generates data set in which at least the correspondence between a color setting value and a weighted average value is extracted, and stores the data set in the memory 12 in association with the colorimetric value database. The colorimetric value database is a database in which a data set ID, a patch set, a type of sheet, a model of printer, and a colorimeter ID are associated with each other. The data set ID is an identifier for identifying a data set. The patch set is information indicating the type of the color chart. The colorimeter ID is an identifier for identifying the model or the individual body of a colorimeter.

The steps of processing a colorimetric value has been presented in the above. The colorimetric value database is used for creating a profile. Specifically, an application program, which creates a profile based on the data set, is installed in the information processor. When an operator selects from the colorimetric value database a data set corresponding to the type of sheet used for printing and the model of a printer, and gives directions for creating a profile based on the data set to the information processor, the information processor creates a profile based on the selected data set, and transmits the created profile to the printer. The printer stores the received profile in the memory 12. When print data is inputted, the printer performs color conversion on the print data in accordance with the profile and executes printing.

According to the exemplary embodiment, in contrast to the case where weight assignment according to a position in the scanning interval is not performed, in the case where the color chart is scanned by the colorimeter and the average value of the colorimetric values of multiple patches for each setting value of color is determined, the reliability of the average value is improved. In addition, according to the exemplary embodiment, in contrast to the case where weight assignment according to elapsed time after calibration is not performed, in the case where the color chart is scanned by the colorimeter and the average value of the colorimetric values of multiple patches for each setting value of color is determined, the reliability of the average value is improved.

The exemplary embodiment may be modified as in the following modifications. Multiple modifications may be combined.

### First Modification

In the exemplary embodiment, in the first interval and the third interval, the weighting value Wp is set to increase linearly as the position is further away from an end point of the scanning interval. However, this is only an example. The distribution of the weighting value Wp in the first and third intervals may be, for instance, a curve convex downward or convex upward, and the weighting value Wp may be set to increase stepwise as the position is further away from an end point. Alternatively, as the weighting value Wp in the first interval and the third interval, a constant value smaller than in the second interval may be set.

### Second Modification

In the exemplary embodiment, the weighting value Wt is set to decrease linearly as elapsed time after calibration increases. However, this is only an example. For instance, in a period in which elapsed time after calibration is less than a threshold value, the weighting value Wt may be set to 1.0, and in a period in which the elapsed time is the threshold value or greater, the weighting value Wt may be set to decrease. Alternatively, the weighting value Wt may be set to decrease stepwise.

### Third Modification

The distribution of the weighting value Wp may vary according to a degree of mastery of colorimetric work by an operator. For instance, the degree of mastery is classified into multiple classes, and a calculation expression or a lookup table for weighting value Wp corresponding to each class is set in an application program in advance. The calculation expression has a different distribution of the weighting value Wp depending on a class. For instance, when the degree of mastery is classified into the upper class (the degree of mastery is relatively high) and the lower class (the degree of mastery is relatively low), in the upper class, the lengths of the first interval and the third interval may be set to be shorter than in the lower class. Alternatively, in the upper class, the weighting value Wp in the first interval and the third interval may be set to be a larger value than in the lower class. The class of the degree of mastery may be selected by an operator, or the information processor may determine the degree of mastery, for instance, by a known technique. Alternatively, a calculation expression showing the relationship between a position and weighting value Wp in the scanning interval may be set by an operator.

### Fourth Modification

An error of a colorimetric value may be determined utilizing the colorimetric value database. For instance, the weighted average value of colorimetric values corresponding to a color setting value is compared with the weighted average value of colorimetric values corresponding to the color setting value in the data sets accumulated in the colorimetric value database, and in the case where the difference between the weighted average values exceeds a threshold value, a message prompting to redo color measurement may be displayed.

### Fifth Modification

In the exemplary embodiment, an example has been shown in which weight assignment is performed using the weighting value Wp and the weighting value Wt. However, weight assignment may be performed using one of the weighting value Wp and the weighting value Wt.

### Sixth Modification

In the exemplary embodiment, an example has been shown in which the color chart is manually scanned. However, the invention may be applied to a configuration in which scanning of the color chart is mechanically performed.

### Seventh Modification

In the exemplary embodiment, an example has been shown in which the information processor has a function of processing a colorimetric value. However, the printer or the colorimeter may have this function. In the case where an external control device is provided in the printer, the control device may have the function of processing a colorimetric value.

In the exemplary embodiment, an example has been shown in which the function of processing a colorimetric value is implemented by software. However, part or all of the function may be implemented by a hardware circuit. The software may be provided by being recorded on a computer readable recording medium such as an optical recording medium or a semiconductor memory, and the software may be read from the recording medium and installed. Alternatively, the software may be provided by a telecommunications line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processor comprising:
an acquisition unit that acquires a colorimetric value from a colorimeter that scans a color chart and measures color; and
an output unit that assigns a weighting value according to a position in a scanning interval of the color chart, and that outputs a weighted average value of the colorimetric value of a plurality of patches for a color setting value.

2. The information processor according to claim 1,
wherein in a first interval including an end point of the scanning interval and shorter than the scanning interval, the output unit assigns a smaller weighting value than in a second interval adjacent to the first interval.

3. The information processor according to claim 2,
wherein in the first interval including the end point of the scanning interval and shorter than the scanning interval, the output unit assigns a larger weighting value as a position is further away from the end point.

4. The information processor according to claim 1,
wherein in addition to assigning a weighting value according to a position in the scanning interval, the output unit assigns a weighting value according to elapsed time after calibration of the colorimeter.

5. The information processor according to claim 2,
wherein in addition to assigning a weighting value according to a position in the scanning interval, the output unit assigns a weighting value according to elapsed time after calibration of the colorimeter.

6. The information processor according to claim 3,
wherein in addition to assigning a weighting value according to a position in the scanning interval, the output unit assigns a weighting value according to elapsed time after calibration of the colorimeter.

7. An information processor comprising:
an acquisition unit that acquires a colorimetric value from a colorimeter that scans a color chart and measures color; and
an output unit that assigns a weighting value according to elapsed time after calibration of the colorimeter, and that outputs a weighted average value of the colorimetric value of a plurality of patches for a color setting value.

8. The information processor according to claim 4,
wherein the output unit assigns a smaller weighting value as elapsed time after calibration increases.

9. The information processor according to claim 5,
wherein the output unit assigns a smaller weighting value as elapsed time after calibration increases.

10. The information processor according to claim 6,
wherein the output unit assigns a smaller weighting value as elapsed time after calibration increases.

11. The information processor according to claim 7,
wherein the output unit assigns a smaller weighting value as elapsed time after calibration increases.

12. A non-transitory computer readable medium storing a program causing a computer to execute a process for color measurement, the process comprising:
acquiring a colorimetric value from a colorimeter that scans a color chart and measures color; and
assigning a weighting value according to a position in a scanning interval of the color chart, and outputting a weighted average value of the colorimetric value of a plurality of patches for a color setting value.
